(19) United States
(12) Patent Application Publication
(10) Pub. No.: US 2017/0238304 A1
(43) Pub. Date: Aug. 17, 2017

(54) UCI TRANSMISSION USING DIFFERENT SUBFRAME TYPES

(71) Applicant: Lenovo Innovations Limited (Hong Kong), Hong Kong (CN)

(72) Inventors: Wei Ling, Beijing (CN); Zukang Shen, Beijing (CN)

(21) Appl. No.: 15/409,297

(22) Filed: Jan. 18, 2017

(30) Foreign Application Priority Data
Jan. 18, 2016 (CN) PCT/CN2016/071248

(51) Int. Cl. H04W 72/04; H04L 5/00

(52) U.S. Cl. CPC H04W 72/0413; H04L 5/0057; H04L 5/0037; H04W 72/0446

(57) ABSTRACT

Apparatuses, methods, and systems are disclosed for communicating UCI using different subframe types. One apparatus includes a transmitter that transmits a first type of UCI using a first subframe of a first subframe type. The transmitter further transmits a second type of UCI using a second subframe, the second subframe having a second subframe type, wherein the duration of the second subframe is larger than the duration of the first subframe. One method includes receiving a first type of UCI via a first subframe of a first subframe type and receiving a second type of UCI via a second subframe, the second subframe having a second subframe type, wherein the duration of the second subframe is larger than the duration of the first subframe.

### FIELD

The subject matter disclosed herein relates generally to wireless communications and more particularly relates to uplink control information transmission using different subframe types are disclosed.

### BACKGROUND

The following abbreviations are herewith defined, at least some of which are referred to within the following description.

3GPP Third Generation Partnership Project

4G Fourth Generation

5G Fifth Generation

AP Access Point

CAZAC Constant Amplitude Zero Autocorrelation

CQI Channel Quality Indication

RI Rank Indication

PMI Precoding Matrix Indicator

PTI Precoding Type Indicator

DL Downlink

eNB Evolved Node B

HARQ Hybrid Automatic Repeat Request

IP Internet Protocol

LAN Local Area Network

LTE Long Term Evolution

MCS Modulation and Coding Scheme

OFDM Orthogonal Frequency Division Multiplexing

PGW Packet Data Network Gateway

PLMN Public Land Mobile Network

PDCCH Physical Downlink Control Channel

PDSCH Physical Downlink Shared Channel

PRB Physical Resource Block

PUCCH Physical Uplink Control Channel

PUSCH Physical Uplink Shared Channel

QPSK Quadrature Phase Shift Keying

RAN Radio Access Network

RF Radio Frequency

RRC Radio Resource Control

RS Reference Signal

SC-FDMA Single Carrier Frequency Division Multiple Access

SGW Serving Gateway

TB Transport Block

TCP Transmission Control Protocol

TTI Transmit Time Interval

UE User Entity/Equipment (Mobile Terminal)

UL Uplink

WAN Wide Area Network

WiMAX Worldwide Interoperability for Microwave Access

WLAN Wireless Local Area Network

In wireless communications networks, such as a 3GPP Long Term Evolution (“LTE”) wireless communication network, user equipment (“UE”) transmits uplink control information (“UCI”) to a base station (e.g., an eNB). Typically, a UCI transmission is composed of UL HARQ feedback, scheduling requests, and channel state information (“CSI”). UL signals are transmitted over a transmit time interval (“TTI”). A HARQ ACK/NACK bit is used to response to a data transmission in the form of a transport block (“TB”), while ACK means a TB is correctly received and NACK means a TB is erroneously received. A scheduling request is used to inform the eNB that the UE has UL data to transmit and therefore need an UL grant.

CSI which consists of channel quality indication (“CQI”), rank indication (“RI”), precoding matrix indicator (“PMI”), and precoding type indicator (“PTI”) is used to help the eNodeB to perform link adaptation. By link adaptation, the eNB determines a set of the UEs to be scheduled for data transmission, as well as the modulation and coding scheme (“MCS”), the number of spatial transmission layers, and the spatial precoding matrix for each of the scheduled UEs. CSI can be configured to be reported periodically or aperiodically. The periodic CSI reporting can be carried on PUCCH format 2/2a/2b in subframes with no PUSCH allocation and also can be carried on PUSCH in subframes with PUSCH allocation, while the aperiodic CSI reporting can only be carried on PUSCH.

In the existing LTE system, periodic CSI can be transmitted using PUCCH format 2/2a/2b. Using normal cyclic prefix as an example, for PUCCH format 2, a CAZAC sequence of length 12 is transmitted in each SC-FDMA symbol. One QPSK constellation point is used to modulate the CAZAC sequence in each OFDM symbol. In each TTI of 1 ms, 10 SC-FDMA symbols can be used to carry 10 QPSK constellation points, while the other 4 SC-FDMA symbols are used for transmission of the reference signals (“RS”). Therefore, in a TTI of 1 ms, PUCCH format 2 can carry 20 coded bits. The CSI information bits ranges from 2 to 11 bits, depending on the CSI reporting mode. The CSI information bits are encoded by a convolutional encoder, which generates 20 coded bits to be transmitted by PUCCH format 2. In addition, a maximum of 12 orthogonal PUCCH format 2 resources can be provided within one PRB, i.e. from the 12 orthogonal CAZAC sequences obtained through cyclic shifting a base CAZAC sequence.

A typical method of latency reduction involves shortening the TTI, which can reduce response time and improve TCP throughput. However, transmitting the periodic CSI using a shortened TTI reduces the number of coded bits that can be transmitted compared to legacy TTI (e.g., TTI of 1 ms), thus reducing the reliability of CSI detection performance. Also, transmitting the periodic CSI using a shortened TTI reduces the multiplexing capacity of CSI transmission, thus reducing the number of UEs that can be multiplexed in the same PRB. Further, transmitting the periodic CSI using a shortened TTI prevents multiplexing CSI from UEs using the shortened TTI and UEs using the legacy TTI, thus increasing the system overhead for CSI transmission.

### BRIEF SUMMARY

Apparatuses for communicating uplink control information (“UCI”) using different subframe types are disclosed. Methods and systems also perform the functions of the apparatuses. In one embodiment, an apparatus includes a transmitter that transmits a first type of UCI using a first subframe of a first subframe type. The transmitter further transmits a second type of UCI using a second subframe, the second subframe having a second subframe type, wherein the duration of the second subframe is larger than the duration of the first subframe.

In one embodiment, the transmitter transmits the first type of UCI using the first subframe on an uplink control channel. In another embodiment, the transmitter transmits the first type of UCI using the first subframe on an uplink data channel. In a further embodiment, the transmitter transmits the second type of UCI using the second subframe on an uplink control channel.

In some embodiments, the transmitter further transmits uplink data on an uplink data channel using a third subframe of the first subframe type. In further embodiments, the transmission of the first type of UCI in the first subframe, the transmission of the second type of UCI in the second subframe, and the transmission of the uplink data in the third subframe are overlapping in time. In certain embodiments, the transmission of the first type of UCI in the first subframe and the transmission of the second type of UCI in the second subframe are overlapping in time.

In one embodiment, the apparatus includes a receiver that receives subframe type configuration information and a processor that configures the transmitter to transmit the first type of UCI using a subframe of the first subframe type based on the subframe type configuration information. In another embodiment, the apparatus includes a receiver that receives subframe type configuration information and a processor that configures the transmitter to transmit an uplink data channel using a subframe of the first subframe type based on the subframe type configuration information.

In one embodiment, first type of UCI includes at least one of a hybrid automatic repeat request (“HARQ”) feedback and a scheduling request. In another embodiment, the second type of UCI includes channel state information (“CSI”) feedback.

A method for communicating UCI using different subframe types includes transmitting a first type of UCI using a first subframe of a first subframe type. The method also includes transmitting a second type of UCI using a second subframe, the second subframe having a second subframe type, wherein the duration of the second subframe is larger than the duration of the first subframe.

In one embodiment, transmitting the first type of UCI using the first subframe comprises transmitting the first type of UCI using the first subframe on an uplink control channel. In another embodiment, transmitting the first type of UCI using the first subframe includes transmitting the first type of UCI using the first subframe on an uplink data channel. In a further embodiment, transmitting the second type of UCI using the second subframe comprises transmitting the second type of UCI using the second subframe on an uplink control channel.

In some embodiments, the method includes transmitting uplink data on an uplink data channel using a third subframe of the first subframe type. In further embodiments, the reception of the first type of UCI in the first subframe, the reception of the second type of UCI in the second subframe, and the reception of the uplink data in the third subframe are overlapping in time. In certain embodiments, the reception of the first type of UCI in the first subframe and the reception of the second type of UCI in the second subframe are overlapping in time.

In some embodiments, the method includes receiving subframe type configuration information, wherein the subframe type configuration information configures transmitting the first type of UCI using a subframe of the first subframe type. In certain embodiments, the method includes receiving subframe type configuration information, wherein the subframe type configuration information configures transmitting an uplink data channel using a subframe of the first subframe type.

In one embodiment, first type of UCI includes at least one of a hybrid automatic repeat request (“HARQ”) feedback and a scheduling request. In another embodiment, the second type of UCI includes channel state information (“CSI”) feedback.

Another apparatus for communicating UCI using different subframe types includes a receiver that receives a first type of UCI using a first subframe of a first subframe type. The receiver further receives a second type of UCI using a second subframe, the second subframe having a second subframe type, wherein the duration of the second subframe is larger than the duration of the first subframe.

In one embodiment, the receiver receives the first type of UCI using the first subframe on an uplink control channel. In another embodiment, the receiver receives the first type of UCI using the first subframe on an uplink data channel. In a further embodiment, the receiver receives the second type of UCI using the second subframe on an uplink control channel.

In some embodiments, the receiver further receives uplink data on an uplink data channel using a third subframe of the first subframe type. In further embodiments, the reception of the first type of UCI in the first subframe, the reception of the second type of UCI in the second subframe, and the reception of the uplink data in the third subframe are overlapping in time. In certain embodiments, the reception of the first type of UCI in the first subframe and the reception of the second type of UCI in the second subframe are overlapping in time.

In one embodiment, the apparatus includes a transmitter that transmits subframe type configuration information, wherein the subframe type configuration information includes an instruction to transmit the first type of UCI using a subframe of the first subframe type. In another embodiment, the apparatus includes a transmitter that transmits subframe type configuration information, wherein the subframe type configuration information includes an instruction to transmit on an uplink data channel using a subframe of the first subframe type.

In one embodiment, first type of UCI includes at least one of a hybrid automatic repeat request (“HARQ”) feedback and a scheduling request. In another embodiment, the second type of UCI includes channel state information (“CSI”) feedback.

Another method for communicating UCI using different subframe types includes receiving a first type of UCI via a first subframe of a first subframe type. The method also includes receiving a second type of UCI via a second subframe, the second subframe having a second subframe type, wherein the duration of the second subframe is larger than the duration of the first subframe.

In one embodiment, receiving the first type of UCI using the first subframe comprises receiving the first type of UCI using the first subframe on an uplink control channel. In another embodiment, receiving the first type of UCI using the first subframe includes receiving the first type of UCI using the first subframe on an uplink data channel. In a further embodiment, receiving the second type of UCI using the second subframe comprises receiving the second type of UCI using the second subframe on an uplink control channel.

In some embodiments, the method includes receiving uplink data on an uplink data channel using a third subframe of the first subframe type. In further embodiments, the reception of the first type of UCI in the first subframe, the reception of the second type of UCI in the second subframe, and the reception of the uplink data in the third subframe are overlapping in time. In certain embodiments, the reception of the first type of UCI in the first subframe and the reception of the second type of UCI in the second subframe are overlapping in time.

In some embodiments, the method includes transmitting subframe type configuration information, wherein the subframe type configuration information includes an instruction to transmit the first type of UCI using a subframe of the first subframe type. In certain embodiments, the method includes transmitting subframe type configuration information, wherein the subframe type configuration information includes an instruction to transmit on an uplink data channel using a subframe of the first subframe type.

In one embodiment, first type of UCI includes at least one of a hybrid automatic repeat request (“HARQ”) feedback and a scheduling request. In another embodiment, the second type of UCI includes channel state information (“CSI”) feedback.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for communicating UCI using different subframe types;

FIG. 2 is a schematic block diagram illustrating one embodiment of an apparatus that may be used for communicating UCI using different subframe types;

FIG. 3 is a schematic block diagram illustrating one embodiment of another apparatus that may be used for communicating UCI using different subframe types;

FIG. 4 is a block diagram illustrating one embodiment of an uplink resource grid that may be used for communicating UCI using different subframe types;

FIG. 5 is a block diagram illustrating another embodiment of an uplink resource grid that may be used for communicating UCI using different subframe types;

FIG. 6 is a block diagram illustrating yet another embodiment of an uplink resource grid that may be used for communicating UCI using different subframe types;

FIG. 7 is a block diagram illustrating still another embodiment of an uplink resource grid that may be used for communicating UCI using different subframe types;

FIG. 8 is a schematic flow chart diagram illustrating one embodiment of a method for communicating UCI using different subframe types; and

FIG. 9 is a schematic flow chart diagram illustrating another embodiment of another method for communicating UCI using different subframe types.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices, or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider (“ISP”)).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

The disclosed apparatuses, methods, and systems facilitate communicating uplink control information (“UCI”) using different subframe types by communicating a first type of UCI using a first subframe having a first subframe type and communicating a second type of UCI using a second subframe, the second subframe having a second subframe type, wherein the duration (e.g., transmit time interval “TTI”) of the second subframe is larger than the duration of the first subframe. Accordingly, a user equipment (“UE”) may transmit some types of UCI using subframes of a subframe type having a shortened TTI while transmitting other types of UCI using subframes of the subframe type using legacy TTI. In one embodiment, the UE may transmit HARQ feedback and/or a scheduling request using subframes of the type having a shortened TTI in order to reduce the overall transmission latency in a wireless communication system. In a further embodiment, the UE may transmit periodic CSI feedback using subframes of the type having legacy TTI, in order to avoid increasing system overhead for communicating CSI feedback, to allow multiplexing of CSI with legacy UEs in the wireless communication system, and to ensure the same coverage of periodic CSI between the UE and the legacy UEs in the wireless communication system. In order to multiplex transmission in the same OFDM or SC-FDMA symbol, with legacy UEs and the improved UEs described herein, the duration of OFDM or SC-FDMA symbol, i.e. the subcarrier spacing as well as the cyclic prefix length, should be common to both legacy UE(s) and the improved UE(s).

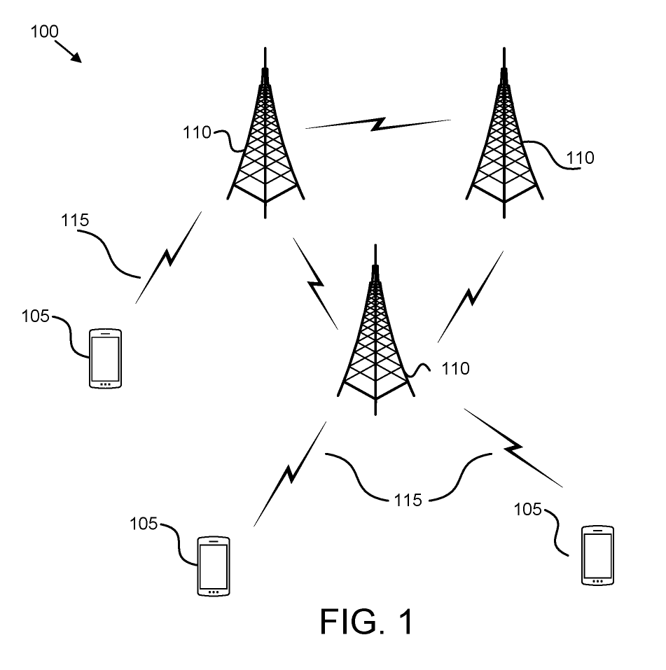

FIG. 1 depicts a wireless communication system 100 for communicating UCI using different subframe types, according to embodiments of the disclosure. In one embodiment, the wireless communication system 100 includes remote units 105, base units 110, and wireless communication links 115. Even though a specific number of remote units 105, base units 110, and wireless communication links 115 are depicted in FIG. 1, one of skill in the art will recognize that any number of remote units 105, base units 110, and wireless communication links 115 may be included in the wireless communication system 100.

In one embodiment, the remote units 105 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as subscriber units, mobiles, mobile stations, users, terminals, mobile terminals, fixed terminals, subscriber stations, UE, user terminals, a device, or by other terminology used in the art. The remote units 105 may communicate directly with a base unit 110 via uplink (“UL”) communication signals. Furthermore, the UL communication signals may be carried over the wireless communication links 115.

The base units 110 may be distributed over a geographic region. In certain embodiments, a base unit 110 may also be referred to as an access point, an access terminal, a base, a base station, a macrocell, a picocell, a femtocell, a Node-B, an eNB, a Home Node-B, a relay node, a device, or by any other terminology used in the art. The base units 110 are generally part of a radio access network that may include one or more controllers communicably coupled to one or more corresponding base units 110.

The base units 110 are generally communicably coupled to one or more packet core networks (“PCN”), which may be coupled to other networks, such as the Internet and public switched telephone networks, among other networks. These and other elements of radio access and core networks are not illustrated but are well known generally by those having ordinary skill in the art. For example, one or more base units 110 may be communicably coupled to a mobility management entity (“MME”), a serving gateway (“SGW”), and/or a packet data network gateway (“PGW”).

The base units 110 may serve a number of remote units 105 within a serving area, for example, a cell or a cell sector via a wireless communication link. The base units 110 may communicate directly with one or more of the remote units 105 via communication signals. The wireless communication links 115 facilitate communication between the remote units 105 and the base units 110.

The base units 110 transmit downlink (“DL”) communication signals to serve the remote units 105 in the time, frequency, and/or spatial domain. Furthermore, the DL communication signals may be carried over the wireless communication links 115. The wireless communication links 115 may be any suitable carrier in licensed or unlicensed radio spectrum. For example, a base unit 110 may be a wireless local area network (“WLAN”) access point (“AP”) which communicates with the remote units 105 over industrial, scientific, and medical (“ISM”) radio bands.

In one implementation, the wireless communication system 100 is compliant with the long-term evolution (“LTE”) of the 3GPP protocol, wherein the base unit 110 transmits using an orthogonal frequency division multiplexing (“OFDM”) modulation scheme on the DL and the remote units 105 transmit on the UL using a single-carrier frequency division multiple access (“SC-FDMA”) scheme. More generally, however, the wireless communication system 100 may implement some other open or proprietary communication protocol, for example, WiMAX, among other protocols. The present disclosure is not intended to be limited to the implementation of any particular wireless communication system architecture or protocol.

In the wireless communication system 100, a base unit 110 may provide configuration information to one or more remote units 105. In certain embodiments, the base unit 110 may provide subframe type configuration information relating to a particular type of UCI. Specifically, the base unit 110 provides subframe type configuration information indicating to the remote unit 105 what types of UCI are to be transmitted using a subframe of a shortened TTI subframe type.

In one embodiment, the base unit 110 provides configuration information relating to transmission on an uplink control channel (e.g., a PUCCH). Specifically, the base unit 110 provides configuration information indicating to the remote unit 105 whether to use uplink subframes of a shortened TTI subframe type for certain types of UCI transmission on the PUCCH. In another embodiment, the base unit 110 may provide configuration information relating to transmission on an uplink data channel (e.g., a PUSCH) using a shortened TTI subframe type. Specifically, the base unit 110 may provide configuration information indicating to unit 105 whether to use uplink subframes of a shortened TTI subframe type for certain types of UCI transmission on the PUSCH. If the remote unit 105 receives configuration information relating to certain types of UCI (e.g., HARQ feedback), but no configuration information relating to other types of UCI (e.g., CSI feedback), then the remote unit 105 may use a shortened TTI for transmission of the indicated types of UCI (e.g., HARQ feedback), but use legacy TTI for transmission of the other types of UCI (e.g., CSI feedback).

In some embodiments, the base unit 110 may provide first configuration information relating to transmission on the PUCCH using a shortened TTI subframe type and second configuration information relating to transmission on the PUSCH using a shortened TTI subframe type. In one embodiment, the base unit 110 provides the first configuration information and the second configuration information at the same time. In other embodiments, however, the base unit 110 may configuration information relating to transmission on the PUCCH at a different point in time than configuration information relating to transmission on the PUSCH. If the remote unit 105 receives configuration information relating to transmission on the PUCCH, but no configuration information relating to transmission on the PUSCH, then the remote unit 105 may use a shortened TTI for transmissions on the PUCCH, but use legacy TTI for transmission on the PUSCH. Similarly, if the remote unit 105 receives configuration information relating to transmission on the PUSCH, but no configuration information relating to transmission on the PUCCH, then the remote unit 105 may use a shortened TTI for transmissions on the PUSCH, but use legacy TTI for transmission on the PUCCH.

A remote unit 105 may transmit a first type of UCI using a first subframe having a first subframe type. For example, the remote unit 105 a transmit HARQ feedback (e.g., first type of UCI) using a first subframe of a shortened TTI subframe type. The remote unit 105 may also transmit a second type of UCI using a second subframe having a second subframe type, wherein the duration of the second subframe is larger than the duration of the first subframe. For example, the remote unit 105 may transmit CSI feedback e.g., second type of UCI) using a second subframe of a legacy TTI subframe type. As configured by the base unit 110, the remote unit 105 may transmit the first type of UCI using the first subframe on an uplink control channel. Alternatively, the remote unit 105 may transmit the first type of UCI using the first subframe on an uplink data channel, as configured by the base unit 110.

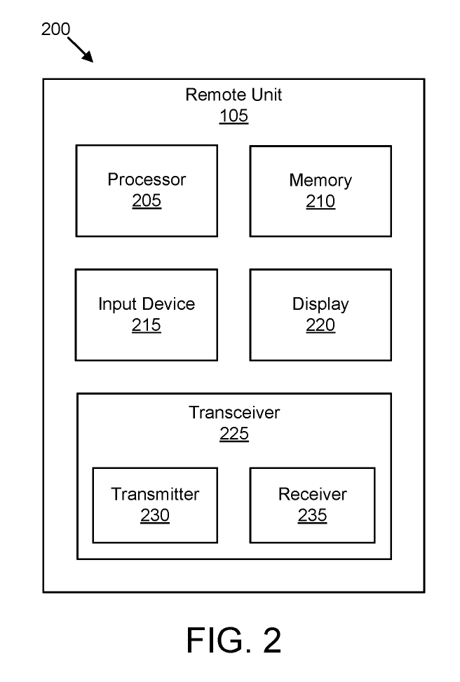

FIG. 2 depicts one embodiment of an apparatus 200 that may be used for communicating UCI using different subframe types. The apparatus 200 includes one embodiment of the remote unit 105. Furthermore, the remote unit 105 may include a processor 205, a memory 210, an input device 215, a display 220, and a wireless transceiver 225. In some embodiments, the input device 215 and the display 220 are combined into a single device, such as a touchscreen. In certain embodiments, the remote unit 105 may not include any input device 215 and/or display 220. In various embodiments, the remote unit 105 may include one or more of the processor 205, the memory 210, and the wireless transceiver 225, and may not include the input device 215 and/or the display 220.

The processor 205, in one embodiment, may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 205 executes instructions stored in the memory 210 to perform the methods and routines described herein. The processor 205 is communicatively coupled to the memory 210, the input device 215, the display 220, and the wireless transceiver 225.

The memory 210, in one embodiment, is a computer readable storage medium. In some embodiments, the memory 210 includes volatile computer storage media. For example, the memory 210 may include a RAM, including dynamic RAM (“DRAM”), synchronous dynamic RAM (“SDRAM”), and/or static RAM (“SRAM”). In some embodiments, the memory 210 includes non-volatile computer storage media. For example, the memory 210 may include a hard disk drive, a flash memory, or any other suitable non-volatile computer storage device. In some embodiments, the memory 210 includes both volatile and non-volatile computer storage media. In some embodiments, the memory 210 stores data relating to an uplink frame type. In some embodiments, the memory 210 also stores program code and related data, such as an operating system or other controller algorithms operating on the remote unit 105.

The input device 215, in one embodiment, may include any known computer input device including a touch panel, a button, a keyboard, a stylus, a microphone, or the like. In some embodiments, the input device 215 may be integrated with the display 220, for example, as a touchscreen or similar touch-sensitive display. In some embodiments, the input device 215 includes a touchscreen such that text may be input using a virtual keyboard displayed on the touchscreen and/or by handwriting on the touchscreen. In some embodiments, the input device 215 includes two or more different devices, such as a keyboard and a touch panel.

The display 220, in one embodiment, may include any known electronically controllable display or display device. The display 220 may be designed to output visual, audible, and/or haptic signals. In some embodiments, the display 220 includes an electronic display capable of outputting visual data to a user. For example, the display 220 may include, but is not limited to, an LCD display, an LED display, an OLED display, a projector, or similar display device capable of outputting images, text, or the like to a user. As another, non-limiting, example, the display 220 may include a wearable display such as a smart watch, smart glasses, a heads-up display, or the like. Further, the display 220 may be a component of a smart phone, a personal digital assistant, a television, a table computer, a notebook (laptop) computer, a personal computer, a vehicle dashboard, or the like.

In certain embodiments, the display 220 includes one or more speakers for producing sound. For example, the display 220 may produce an audible alert or notification (e.g., a beep or chime). In some embodiments, the display 220 includes one or more haptic devices for producing vibrations, motion, or other haptic feedback. In some embodiments, all or portions of the display 220 may be integrated with the input device 215. For example, the input device 215 and display 220 may form a touchscreen or similar touch-sensitive display. In other embodiments, the display 220 may be located near the input device 215.

The wireless transceiver 225, in one embodiment, is configured to communicate wirelessly with the base unit 110, for example using RF signals. The wireless transceiver 225 includes at least one transmitter 230 that transmits UL communication signals to the base unit 110 and at least one receiver 235 that receives DL communication signals from the base unit 110. In one embodiment, the transmitter 230 transmits UCI over an uplink control channel and/or an uplink data channel and the receiver 235 receives DL signals on at least one downlink channel.

The wireless transceiver 225 may include any suitable number of transmitters 230 and receivers 235. The transmitter 230 and the receiver 235 may be any suitable type of transmitters and receivers. For example, in some embodiments, the wireless transceiver 225 includes a plurality of transmitter 230 and receiver 235 sets for communicating on a plurality of wireless networks and/or radio frequency bands, each transmitter 230 and receiver 235 set configured to communicate on a different wireless network and/or radio frequency band than the other transmitter 230 and receiver 235 sets.

In some embodiments, the transmitter 230 sends a first type of UCI using a first subframe having a first subframe type. For example, the transmitter 230 may send the first type of UCI using a subframe of a shortened TTI subframe type. The transmitter 230 also sends a second type of UCI using a second subframe having a second subframe type, wherein the duration (e.g., the TTI) of the second subframe is larger than the duration (e.g., TTI) of the first subframe. For example, the first type of UCI may include hybrid automatic repeat request (“HARQ”) feedback and/or a scheduling request. As another example, the second type of UCI may include channel state information (“CSI”) feedback.

In one embodiment, the transmitter 230 transmits the first type of UCI using the first subframe over an uplink control channel. In another embodiment, the transmitter 230 transmits the first type of UCI using the first subframe over an uplink data channel. Similarly, the transmitter 230 may transmit the second type of UCI using the second subframe over either an uplink control channel or an uplink data channel, based on an allocation by the base unit 110.

In certain embodiments, the transmitter 230 additionally transmits uplink data on an uplink data channel using a third subframe of the first subframe type. For example, the first subframe type may have a shortened TTI (as compared to other subframe types), wherein the processor 205 controls the transmitter 230 transmit UCI using a first subframe having a shortened TTI and also transmit uplink data using a third subframe having the shortened TTI. In some embodiments, the transmission of the first type of UCI in the first subframe, the transmission of the second type of UCI in the second subframe, and the transmission of uplink data in the third subframe may overlap in time.

Similarly, in certain embodiments the transmission of the first type of UCI in the first subframe and the transmission of the second type of UCI in the second subframe may overlap in time. In one embodiment, the transmissions of the different subframes (e.g., the transmissions of the first subframe, second subframe, and/or third subframe) may overlap one another in time. For example, the transmission of the first subframe (having a shortened TTI subframe type) may completely overlap the transmission of the third subframe (having the same shortened TTI subframe type) in time. As another example, the transmission of the second subframe (e.g. having a legacy TTI subframe type) may partially overlap the transmission of the first subframe and/or third subframe. As used herein, a transmission in a subframe comprises transmitting during at least one SC-FDMA (or OFDM) symbol in the subframe. Accordingly, the transmission in a subframe may include transmitting during all SC-FDMA (or OFDM) symbols in the subframe, but does not require transmitting during all SC-FDMA (or OFDM) symbols in the subframe. Thus, in certain embodiments, the actual transmission of the multiple subframes may overlap during one or more SC-FDMA (or OFDM) symbols.

In some embodiments, the receiver 235 may receive from the base unit 110 subframe type configuration information, wherein the processor 205 may control the transmitter 230 to transmit UCI based on the subframe type configuration information. In one embodiment, the subframe type configuration information may include one or more instructions configuring transmission of a particular type of UCI using a particular subframe type. In another embodiment, the subframe type configuration information may include one or more instructions configuring transmission over a particular type of uplink channel (e.g., an uplink data channel or an uplink control channel). In certain embodiments, a subframe type configuration information message may include configuration information (e.g., parameters) for both the UCI type and subframe type as well as the uplink channel type. In other embodiments, configuration information (e.g., parameters) for the UCI type and subframe type may be sent via a separate subframe type configuration message from configuration information for the uplink channel type.

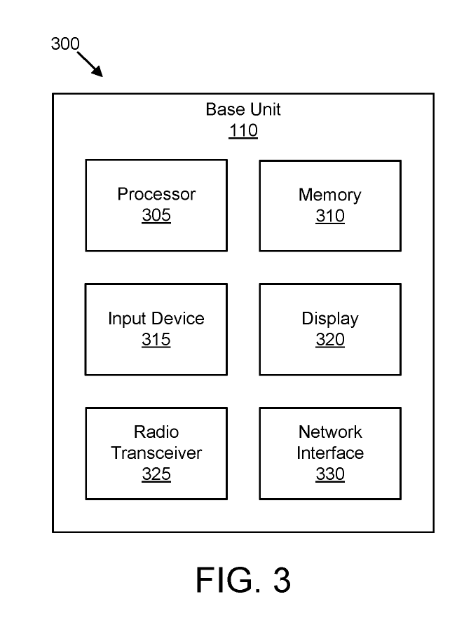

FIG. 3 depicts another embodiment of an apparatus 300 that may be used for communicating UCI using different subframe types. The apparatus 300 includes one embodiment of the base unit 110. Furthermore, the base unit 110 may include a processor 305, a memory 310, an input device 315, a display 320, a wireless transceiver 325, and a network interface 330. As may be appreciated, the processor 305, the memory 310, the input device 315, and the display 320 may be substantially similar to the processor 205, the memory 210, the input device 215, and the display 220 of the apparatus 200, respectively. In some embodiments, the input device 315 and the display 320 are combined into a single device, such as a touchscreen. In certain embodiments, the base unit 110 may include one or more of the processor 305, the memory 310, the wireless transceiver 325, and the network interface 330, and may not include the input device 315 and/or the display 320.

In some embodiments, the processor 305 controls the wireless transceiver 325 to transmit DL signals to a remote unit 105. The processor 305 may also control the wireless transceiver 325 to receive UL signals from the remote unit 105, such as UL signals containing UCI. For example, the processor 305 may control the wireless transceiver 325 to receive uplink communications from a remote unit 105 and transmit downlink communication to the remote unit 105. As another example, the processor 305 may control the wireless transceiver 325 to send configuration information to the remote unit 105.

The wireless transceiver 325, in one embodiment, is configured to communicate wirelessly with the remote unit 105, for example using RF signals. In certain embodiments, the wireless transceiver 325 comprises a transmitter used to transmit downlink communication signals to the remote unit 105 and a receiver used to receive uplink communication signals from the remote unit 105. For example, a receiver in the wireless transceiver 325 may receive UCI over an uplink control channel and/or an uplink data channel. As another example, a transmitter in the wireless transceiver 325 may receive DL signals on at least one downlink channel.

The wireless transceiver 325 may communicate simultaneously with a plurality of remote units 105. For example, the transmitter may transmit DL communication signals to be received by multiple remote units 105. As another example, the receiver may simultaneously receive UL communication signals from multiple remote units 105. The wireless transceiver 325 may include any suitable number and any suitable types of transmitters and receivers. Upon connecting with a remote unit 105, the base unit 110 may relay data between the remote unit 105 and a packet network (e.g., an enhanced packet core network) via the wireless transceiver 325 and the network interface 330, the network interface 330 connecting the base unit 110 to the packet network.

In some embodiments, the wireless transceiver 325 receives a first type of UCI using a first subframe having a first subframe type. The wireless transceiver 325 also receives a second type of UCI using a second subframe having a second subframe type, wherein the duration (e.g., the TTI) of the second subframe is larger than the duration (e.g., TTI) of the first subframe. For example, the first type of UCI may include hybrid automatic repeat request (“HARQ”) feedback and/or a scheduling request. As another example, the second type of UCI may include channel state information (“CSI”) feedback.

In one embodiment, the wireless transceiver 325 receives the first type of UCI using the first subframe over an uplink control channel. In another embodiment, the wireless transceiver 325 receives the first type of UCI using the first subframe over an uplink data channel. Similarly, the wireless transceiver 325 may receive the second type of UCI using the second subframe over either an uplink control channel or an uplink data channel, based on an allocation to the remote unit 105.

In certain embodiments, the wireless transceiver 325 additionally receives uplink data on an uplink data channel using a third subframe of the first subframe type. For example, the first subframe type may have a shortened TTI (as compared to other subframe types), wherein the remote unit 105 transmits (and the wireless transceiver 325 receives) the UCI using a first subframe having a shortened TTI and uplink data using a third subframe having the shortened TTI. In some embodiments, the reception of the first type of UCI in the first subframe, the reception of the second type of UCI in the second subframe, and the reception of uplink data in the third subframe may overlap in time.

Similarly, in certain embodiments the reception of the first type of UCI in the first subframe and the reception of the second type of UCI in the second subframe may overlap in time. In one embodiment, the receptions of the different subframes (e.g., of the first subframe, second subframe, and/or third subframe) may partially overlap one another in time, while in another embodiment the receptions of the different subframes may completely overlap one another in time. As discussed above, the reception of the multiple subframes may overlap during one or more SC-FDMA (or OFDM) symbols.

In some embodiments, the wireless transceiver 325 may transmit subframe type configuration information to the remote unit 105, wherein the remote unit 105 transmits the UCI based on the subframe type configuration information. In one embodiment, the subframe type configuration information may include one or more instructions configuring transmission of a particular type of UCI using a particular subframe type. In another embodiment, the subframe type configuration information may include one or more instructions configuring transmission over a particular type of uplink channel (e.g., an uplink data channel or an uplink control channel). In certain embodiments, a subframe type configuration information message may include configuration information (e.g., parameters) for both the UCI type and subframe type as well as the uplink channel type. In other embodiments, configuration information (e.g., parameters) for the UCI type and subframe type may be sent via a separate subframe type configuration message from configuration information for the uplink channel type.

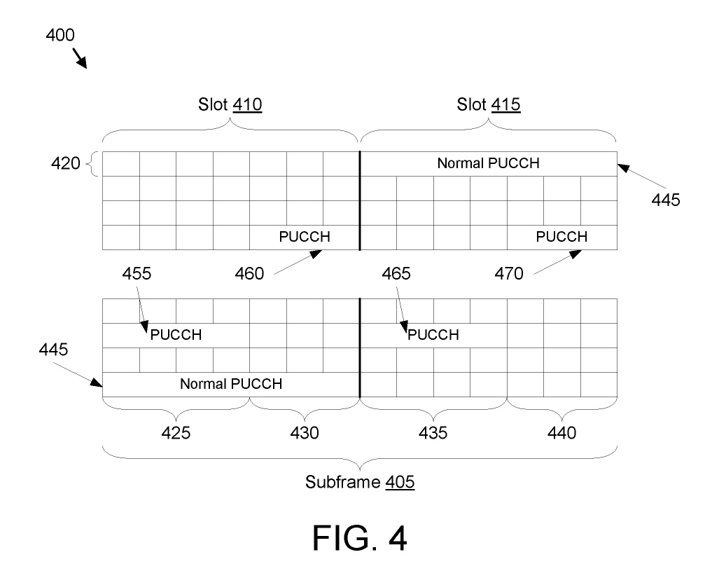

FIG. 4 illustrates an uplink (“UL”) resource grid 400 for communicating UCI using different subframe types, according to embodiments of the disclosure. In one embodiment, the remote unit 105 uses the UL resource grid 400 to transmit periodic CSI reports, according to a periodic CSI reporting configuration of the remote unit 105. The remote unit 105 also uses the UL resource grid 400 to transmit other UCI (e.g., HARQ feedback and/or scheduling requests) to the base unit 110. In a further embodiment, the base unit 110 may transmit subframe type configuration information to the remote unit 105, the subframe type configuration information configuring UL transmissions of certain types of UCI using a subframe type having a shortened TTI.

The UL resource grid 400 is to be transmitted over a subframe 405 having a duration of 1 ms. The subframe 405 contains fourteen SC-FDMA symbols. As depicted, the 1 ms subframe 405 includes two slots: the first slot 410 and the second slot 415. Each of the slots 410 and 415 contain seven SC-FDMA symbols, and each of the slots 410 and 415 have a duration of 0.5 ms. Further, the UL resource grid 400 includes a plurality of physical resource blocks 420. As discussed above, each physical resource block 5 contains a number of subcarriers.

The UL resource grid 400 may further be divided into four shortened subframes 425-440 using a subframe type having a shortened TTI. The first shortened subframe 425 and third shortened subframe 435 each have a TTI of four SC-FDMA symbols. The second shortened subframe 430 and fourth shortened subframe 440 each have a TTI of three SC-FDMA symbols. Thus, the first shortened subframe 425 and the second shortened subframe 430 cover the first slot 410 of the subframe 405, while the second shortened subframe 435 and the fourth shortened subframe 440 cover the second slot 415 of the subframe 405.

Here, the base unit 110 configures the remote unit 105 to transmit HARQ feedback and/or scheduling requests using a subframe type having shortened TTI. Additionally, the base unit 110 configures the remote unit 105 to transmit the HARQ feedback and/or scheduling requests using the shortened TTI type of subframes (e.g., shortened subframes 425-440) on an uplink control channel (e.g., a PUCCH). By default, the remote unit 105 transmits periodic CSI feedback on the normal uplink control channel (e.g., normal PUCCH) using a subframe of the legacy TTI subframe type (e.g., the 1 ms subframe 405). However, the remote unit 105 transmits periodic CSI feedback on an uplink data channel (e.g., PUSCH) using a subframe of the shortened TTI subframe type if the base unit 110 allocates resources to the remote unit 105 on the uplink data channel at the beginning of the subframe 405 (e.g., allocates PUSCH during the first shortened subframe 425).

As depicted, there is no allocation of PUSCH during the subframe 405. Accordingly, the remote unit 105 transmits the periodic CSI on the normal PUCCH using the legacy subframe type (e.g., the 1 ms subframe 405). As shown, the normal periodic CSI reporting includes a CSI transmission 445 on the normal PUCCH, e.g., using PUCCH format 2/2a/2b.

At the same time, the remote unit 105 may transmit HARQ feedback and/or a scheduling request in one or more of the shortened subframes 425-440. In one embodiment, the HARQ feedback bits correspond to DL signals received by the remote unit 105 on a physical downlink shared channel (PDSCH) using shortened TTI. In certain embodiments, HARQ feedback and a scheduling request may be multiplexed onto the same shortened subframe 425-440.

As depicted, transmitting the HARQ feedback and scheduling request in the subframe 405 includes a first UCI transmission 455 during the first shortened subframe 425, a second UCI transmission 460 during the second shortened subframe 430, a third UCI transmission 465 during the third shortened subframe 435, and a fourth UCI transmission 470 during the fourth shortened subframe 440. The remote unit 105 transmits the UCI transmissions 455-470 using a shortened subframe type and over an uplink control channel. In one embodiment, the first UCI transmission 455 and the third UCI transmission 465 are transmitted on one set of subcarriers, while the second UCI transmission 460 and the fourth UCI transmission 470 are transmitted on a different set of subcarriers.

As depicted, the remote unit 105 may simultaneously transmit periodic CSI using normal PUCCH with legacy TTI (e.g., CSI transmission 445) and HARQ feedback (and/or scheduling request) using PUCCH configured for shortened TTI (e.g., transmissions 455-470), all on different physical resource blocks 420. Thus, the CSI transmission 445 may overlap in time (e.g., overlap in at least one SC-FDMA symbol) with the transmissions 455, 460, 465, and 470.

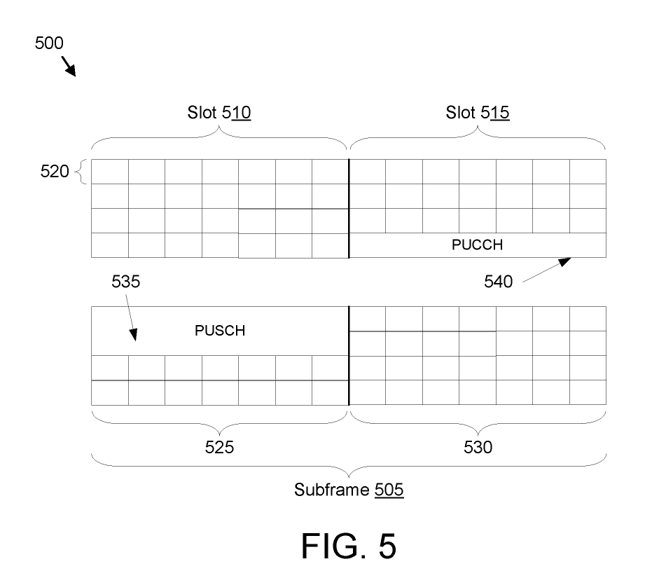

FIG. 5 illustrates an uplink (“UL”) resource grid 500 for communicating UCI using different subframe types, according to embodiments of the disclosure. In one embodiment, the remote unit 105 uses the UL resource grid 500 to transmit periodic CSI reports, according to a periodic CSI reporting configuration of the remote unit 105. The remote unit 105 may also use the UL resource grid 500 to transmit other UCI (e.g., HARQ feedback and/or scheduling requests) to the base unit 110. In a further embodiment, the remote unit 105 may receive subframe type configuration information from the base unit 110, the subframe type configuration information configuring UL transmissions of certain types of UCI using a subframe type having a shortened TTI.

The UL resource grid 500 is to be transmitted over a subframe 505 having a duration of 1 ms. The subframe 505 contains fourteen SC-FDMA symbols. As depicted, the 1 ms subframe 505 includes two slots: the first slot 510 and the second slot 515. Each of the slots 510 and 515 contain seven SC-FDMA symbols, and each of the slots 510 and 515 have a duration of 0.5 ms. Further, the UL resource grid 500 includes a plurality of physical resource blocks 520. As discussed above, each physical resource block 520 contains a number of subcarriers.

The remote unit 105 may transmit UCI to the base unit 110 using a subframe type having a shortened TTI. The first shortened subframe 525 and second shortened subframe 530 are examples of subframes of a shortened TTI subframe type. As depicted, each of the shortened subframes 525-530 have a TTI of seven SC-FDMA symbols. By default, the remote unit 105 transmits periodic CSI feedback on the normal uplink control channel (e.g., normal PUCCH) using a subframe of the legacy TTI subframe type (e.g., the 1 ms subframe 505). However, the remote unit 105 transmits periodic CSI feedback on an uplink data channel (e.g., PUSCH) using a subframe of the shortened TTI subframe type if the base unit 110 allocates resources to the remote unit 105 on the uplink data channel at the beginning of the subframe 505 (e.g., allocates PUSCH during the first shortened subframe 525).

As depicted, there is a PUSCH allocation using a subframe of the shortened TTI subframe type during the first shortened subframe 525, the PUSCH allocation including two sets of subcarriers during the first slot 510. Accordingly, the normal periodic CSI reporting includes the remote unit 105 transmitting a first UCI transmission 535 on a PUSCH configured for shortened TTI over two set of subcarriers during the first slot 510. The first UCI transmission 535 includes CSI feedback for the periodic CSI reporting.

The first UCI transmission 535 may be limited to certain types of UCI (e.g., CSI feedback). In one embodiment, the first UCI transmission 535 may additionally include HARQ feedback multiplexed with the CSI feedback. Thus, the remote unit 105 may transmit HARQ feedback using a subframe type having shortened TTI (e.g., using the first shortened subframe 525) and on an uplink data channel. In certain embodiments, the HARQ feedback sent during the first slot 510 corresponds to DL signals received by the remote unit 105 on a physical downlink shared channel (PDSCH) using shortened TTI (e.g., of the same duration as the shortened subframe 525).

Additionally, the base unit 110 configures the remote unit 105 to transmit HARQ feedback and/or scheduling requests using a subframe type having shortened TTI (e.g., using shortened subframes 525-530) and on an uplink control channel (e.g., a PUCCH). Accordingly, the remote unit 105 transmits a second UCI transmission 540 on a PUCCH configured for shortened TTI over a set of subcarriers during the second slot 515. The second UCI transmission 540 may be limited to certain types of UCI (e.g., HARQ feedback and/or scheduling requests). In certain embodiments, the HARQ feedback sent during the first slot 510 corresponds to DL signals received by the remote unit 105 on a physical downlink shared channel (PDSCH) using shortened TTI. In one embodiment, the remote unit 105 may multiplex HARQ feedback and a scheduling request to send using the shortened subframe 530 on the uplink control channel.

In one embodiment, the remote unit 105 may transmit uplink data and/or uplink control information during the subframe 505 using a subframe type having a legacy TTI (not shown). Thus, the remote unit 105 may concurrently transmit UL signals using subframes having legacy TTI (e.g., a TTI of 1 ms) and UL signals using subframes having shortened TTI.

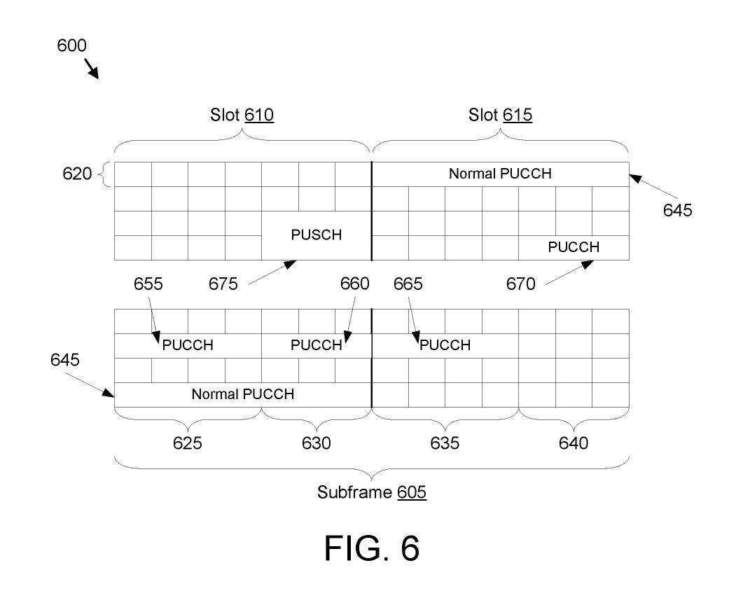

FIG. 6 illustrates an uplink (“UL”) resource grid 600 for communicating UCI using different subframe types, according to embodiments of the disclosure. In one embodiment, the remote unit 105 uses the UL resource grid 600 to transmit periodic CSI reports, according to a periodic CSI reporting configuration of the remote unit 105. The remote unit 105 also uses the UL resource grid 600 to transmit other UCI (e.g., HARQ feedback and/or scheduling requests) to the base unit 110. In a further embodiment, the base unit 110 may transmit subframe type configuration information to the remote unit 105, the subframe type configuration information configuring UL transmissions of certain types of UCI using a subframe type having a shortened TTI.

The UL resource grid 600 is to be transmitted over a subframe 605 having a duration of 1 ms. The subframe 605 contains fourteen SC-FDMA symbols. As depicted, the 1 ms subframe 605 includes two slots: the first slot 610 and the second slot 615. Each of the slots 610 and 615 contain seven SC-FDMA symbols, and each of the slots 610 and 615 have a duration of 0.5 ms. Further, the UL resource grid 600 includes a plurality of physical resource blocks 620. As discussed above, each physical resource block 620 contains a number of subcarriers.

The UL resource grid 600 may further be divided into four shortened subframes 625-640 using a subframe type having a shortened TTI. The first shortened subframe 625 and third shortened subframe 635 each have a TTI of four SC-FDMA symbols. The second shortened subframe 630 and fourth shortened subframe 640 each have a TTI of three SC-FDMA symbols. Thus, the first shortened subframe 625 and the second shortened subframe 630 cover the first slot 610 of the subframe 605, while the second shortened subframe 635 and the fourth shortened subframe 640 cover the second slot 615 of the subframe 605.

In the depicted embodiments, the base unit 110 configures the remote unit 105 to transmit HARQ feedback and/or scheduling requests using a subframe type having shortened TTI. Additionally, the base unit 110 configures the remote unit 105 to transmit the HARQ feedback and/or scheduling requests using the shortened TTI type of subframes (e.g., shortened subframes 625-640) on an uplink control channel (e.g., a PUCCH). By default, the remote unit 105 transmits periodic CSI feedback on the normal uplink control channel (e.g., normal PUCCH) using a subframe of the legacy TTI subframe type (e.g., the 1 ms subframe 605). However, the remote unit 105 transmits periodic CSI feedback on an uplink data channel (e.g., PUSCH) using a subframe of the shortened TTI subframe type if the base unit 110 allocates resources to the remote unit 105 on the uplink data channel at the beginning of the subframe 605 (e.g., allocates PUSCH during the first shortened subframe 625)

As depicted, there is no allocation of PUSCH during the first shortened subframe 625. Accordingly, the remote unit 105 transmits the periodic CSI on the normal uplink control channel (e.g., normal PUCCH) using the legacy subframe type (e.g., the subframe 605 having a TTI of 1 ms). As shown, the normal periodic CSI reporting includes a CSI transmission 645 on the normal PUCCH, e.g., using PUCCH format 2/2a/2b.

At the same time, the remote unit 105 may transmit HARQ feedback and/or a scheduling request in one or more of the shortened subframes 625-640. In one embodiment, the HARQ feedback bits correspond to DL signals received by the remote unit 105 on a physical downlink shared channel (PDSCH) using shortened TTI. In certain embodiments, HARQ feedback and a scheduling request may be multiplexed onto the same shortened subframe 625-640.

As depicted, transmitting the HARQ feedback and scheduling request in the subframe 605 includes a first UCI transmission 655 during the first shortened subframe 625, a second UCI transmission 660 during the second shortened subframe 630, a third UCI transmission 665 during the third shortened subframe 635, and a fourth UCI transmission 670 during the fourth shortened subframe 660. The remote unit 105 transmits the UCI transmissions 655-670 using a shortened subframe type and over an uplink control channel. In one embodiment, the first UCI transmission 655 and the third UCI transmission 665 are transmitted on one set of subcarriers, while the second UCI transmission 660 and the fourth UCI transmission 670 are transmitted on a different set of subcarriers.

Concurrently, the remote unit 105 may be allocated additional uplink resources on an uplink data channel (e.g., PUSCH) for transmitting uplink data. Here, the remote unit 105 is allocated uplink resources of the subframe type having shortened TTI. Thus, the remote unit 105 transmits 675 uplink data on the PUSCH using the second shortened subframe 630 (e.g., using a subframe of the subframe type having shortened TTI) and on two sets of subcarriers. In one embodiment, the transmission 675 includes HARQ feedback and/or a scheduling request multiplexed with the uplink data.

Accordingly, during the second shortened subframe 630 the remote unit 105 may simultaneously transmit periodic CSI using normal PUCCH with legacy TTI (e.g., CSI transmission 645), HARQ feedback (and/or scheduling request) using PUCCH configured for shortened TTI (e.g., transmission 660), and uplink data on a PUSCH configured for shortened TTI (e.g., transmission 675), all on different physical resource blocks 620. Thus, the transmissions 645, 660, and 675 may overlap in time (e.g., overlap in at least one SC-FDMA symbol). Additionally, during the shortened subframes 625, 630, 635, and 640 the remote unit 105 may simultaneously transmit periodic CSI using normal PUCCH with legacy TTI (e.g., CSI transmission 645) and HARQ feedback (and/or scheduling request) using PUCCH configured for shortened TTI (e.g., transmissions 655-670), all on different physical resource blocks 620. Thus, the CSI transmission 645 may overlap in time (e.g., overlap in at least one SC-FDMA symbol) with the transmissions 655, 660,665, and 670.

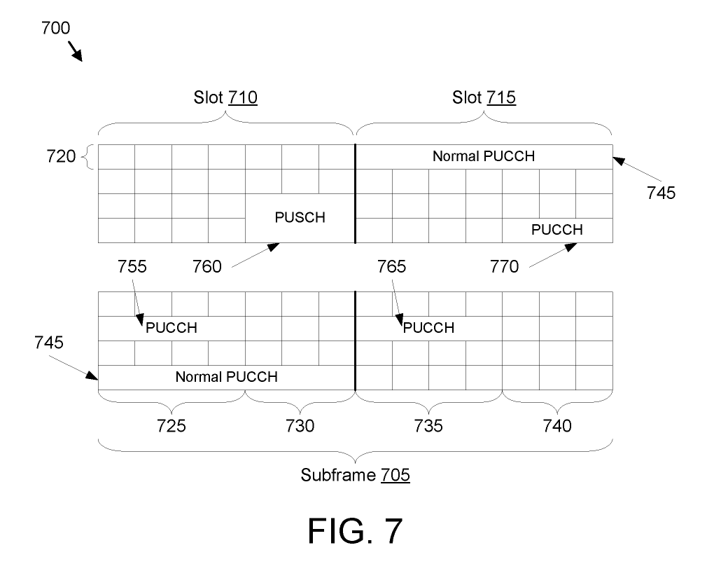

FIG. 7 illustrates an uplink (“UL”) resource grid 700 for communicating UCI using different subframe types, according to embodiments of the disclosure. In one embodiment, the remote unit 105 uses the UL resource grid 700 to transmit periodic CSI reports, according to a periodic CSI reporting configuration of the remote unit 105. The remote unit 105 also uses the UL resource grid 700 to transmit other UCI (e.g., HARQ feedback and/or scheduling requests) to the base unit 110. In a further embodiment, the base unit 110 may transmit subframe type configuration information to the remote unit 105, the subframe type configuration information configuring UL transmissions of certain types of UCI using a subframe type having a shortened TTI.

The UL resource grid 700 is to be transmitted over a subframe 705 having a duration of 1 ms. The subframe 705 contains fourteen SC-FDMA symbols. As depicted, the 1 ms subframe 705 includes two slots: the first slot 710 and the second slot 715. Each of the slots 710 and 715 contain seven SC-FDMA symbols, and each of the slots 710 and 715 have a duration of 0.5 ms. Further, the UL resource grid 700 includes a plurality of physical resource blocks 720. As discussed above, each physical resource block 720 contains a number of subcarriers.

The UL resource grid 700 may further be divided into four shortened subframes 725-740 using a subframe type having a shortened TTI. The first shortened subframe 725 and third shortened subframe 735 each have a TTI of four SC-FDMA symbols. The second shortened subframe 730 and fourth shortened subframe 740 each have a TTI of three SC-FDMA symbols. Thus, the first shortened subframe 725 and the second shortened subframe 730 cover the first slot 710 of the subframe 705, while the second shortened subframe 735 and the fourth shortened subframe 740 cover the second slot 715 of the subframe 705.

In the depicted embodiments, the base unit 110 configures the remote unit 105 to transmit HARQ feedback and/or scheduling requests using a subframe type having shortened TTI. Additionally, the base unit 110 configures the remote unit 105 to transmit the HARQ feedback and/or scheduling requests using the shortened TTI type of subframes (e.g., shortened subframes 725-740) on an uplink control channel (e.g., a PUCCH). By default, the remote unit 105 transmits periodic CSI feedback on the normal uplink control channel (e.g., normal PUCCH) using a subframe of the legacy TTI subframe type (e.g., the 1 ms subframe 705). However, the remote unit 105 transmits periodic CSI feedback on an uplink data channel (e.g., PUSCH) using a subframe of the shortened TTI subframe type if the base unit 110 allocates resources to the remote unit 105 on the uplink data channel at the beginning of the subframe 705 (e.g., allocates PUSCH during the first shortened subframe 725).

As depicted, there is no allocation of PUSCH during the first shortened subframe 725. Accordingly, the remote unit 105 transmits the periodic CSI on the normal PUCCH using the legacy subframe type (e.g., the subframe 705 having a TTI of 1 ms). As shown, the normal periodic CSI reporting includes a CSI transmission 745 on the normal PUCCH, e.g., using PUCCH format 2/2a/2b.

At the same time, the remote unit 105 may transmit HARQ feedback and/or a scheduling request in one or more of the shortened subframes 725-740. Further, the base unit 110 may allocate uplink resources on an uplink data channel for a subframe type having a shortened TTI. In one embodiment, the HARQ feedback bits correspond to DL signals received by the remote unit 105 on a physical downlink shared channel (PDSCH) using shortened TTI. In certain embodiments, HARQ feedback and a scheduling request may be multiplexed onto the same shortened subframe 725-740.

As depicted, transmitting the HARQ feedback and scheduling request in the subframe 705 includes a first shortened PUCCH transmission 755 during the first shortened subframe 725, a second shortened PUCCH transmission 765 during the third shortened subframe 735, and a third shortened PUCCH transmission 770 during the fourth shortened subframe 760. The remote unit 105 transmits the shortened PUCCH transmissions 755, 765, and 770 using a shortened subframe type and over an uplink control channel. In one embodiment, the first shortened PUCCH transmission 755 and the second shortened PUCCH transmission 765 are transmitted on one set of subcarriers, while the third UCI transmission 770 is transmitted on a different set of subcarriers.

Further, the base station 110 may allocate uplink resources on an uplink data channel (e.g., PUSCH) configured for shortened TTI. As depicted, the remote unit 105 may thus transmit 760 HARQ feedback and/or a scheduling request over the PUSCH configured for shortened TTI using a subframe type having a shortened TTI (e.g., the shortened subframe 730) and over two sets of subcarriers. Accordingly, the remote unit 105 may simultaneously transmit periodic CSI using normal PUCCH with legacy TTI (e.g., CSI transmission 745) and HARQ feedback (and/or scheduling request) using PUCCH configured for shortened TTI (e.g., transmissions 755-770), all on different physical resource blocks 720. Thus, the CSI transmission 745 may overlap in time (e.g., overlap in at least one SC-FDMA symbol) with the transmissions 755, 760, 765, and 770.

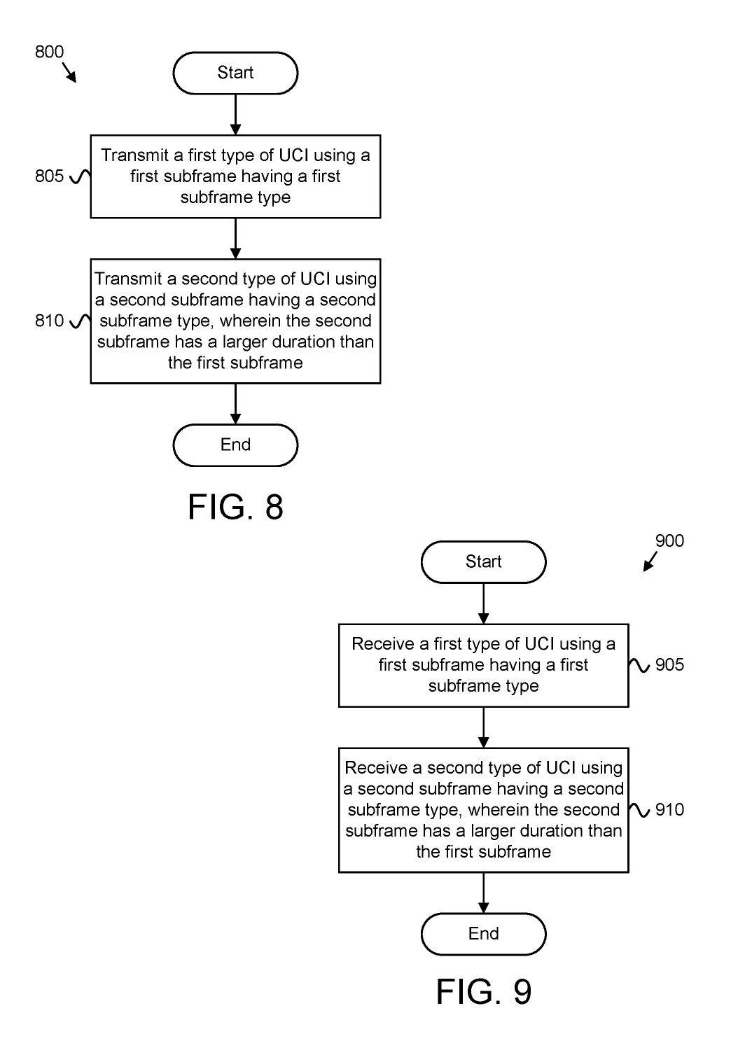

FIG. 8 is a schematic flow chart diagram illustrating a method 800 for communicating UCI using different subframe types, according to embodiments of the disclosure. In some embodiments, the method 800 is performed by an apparatus, such as the remote unit 105. In certain embodiments, the method 800 may be performed by a processor executing program code, for example, a microcontroller, a microprocessor, a CPU, a GPU, an auxiliary processing unit, a FPGA, or the like.

The method 800 includes transmitting 805 a first type of uplink control information (“UCI”) using a first subframe of a first subframe type. In one embodiment, the transmitter 230 transmits 805 the first type of UCI using the first subframe, the first subframe having a first subframe type. In some embodiments, transmitting 805 the first type of UCI using the first subframe includes transmitting the first type of UCI using the first subframe on an uplink control channel. In other embodiments, transmitting 805 the first type of UCI using the first subframe includes transmitting the first type of UCI using the first subframe on an uplink data channel. In yet other embodiments, transmitting 805 the first type of UCI using the first subframe includes both transmitting the first type of UCI using a first subframe of the first subframe type on an uplink control channel and also transmitting the first type of UCI using another subframe of the first subframe type on an uplink data channel.

The method 800 includes transmitting 810 a second type of UCI using a second subframe, the second subframe having a second subframe type, wherein the duration of the second subframe is larger than the duration of the first subframe. The method 800 ends. In one embodiment, the transmitter 230 transmits 810 the second type of UCI using the second subframe, the second subframe having a second subframe type. In certain embodiments, a transmit time interval (“TTI”) of the second subframe is larger than the TTI of the first subframe. In some embodiments, transmitting 810 the second type of UCI using the second subframe includes transmitting the second type of UCI using the second subframe on an uplink control channel.

In some embodiments, transmitting 805 the first type of UCI using the first subframe having the first subframe type and transmitting 810 the second type of UCI using the second subframe having the second subframe type occurs simultaneously, such that the transmission of the first type of UCI in the first subframe and the transmission of the second type of UCI in the second subframe overlap in time. In certain embodiments, the transmitter 230 transmits uplink data on an uplink data channel using a third subframe of the first subframe type, wherein the transmission of the first type of UCI in the first subframe, the transmission of the second type of UCI in the second subframe, and the transmission of the uplink data in the third subframe are overlapping in time.

In certain embodiments, the remote unit 105 may receive subframe type configuration information from a base unit 110. In one embodiment, the subframe type configuration information includes an instruction to transmit the first type of UCI using a subframe of the first subframe type. In another embodiment, the subframe type configuration information includes an instruction to transmit on an uplink data channel using a subframe of the first subframe type. The first type of UCI may include HARQ feedback and/or a scheduling request. The second type of UCI may include CSI feedback.

FIG. 9 is a schematic flow chart diagram illustrating a method 900 for communicating UCI using different subframe types, according to embodiments of the disclosure. In some embodiments, the method 900 is performed by an apparatus, such as the base unit 110. In certain embodiments, the method 900 may be performed by a processor executing program code, for example, a microcontroller, a microprocessor, a CPU, a GPU, an auxiliary processing unit, a FPGA, or the like.

The method 900 includes receiving 905 a first type of uplink control information (“UCI”) using a first subframe having a first subframe type. In one embodiment, a receiver of the wireless transceiver 325 receives 905 the first type of UCI using the first subframe, the first subframe having a first subframe type. In some embodiments, receiving 905 the first type of UCI using the first subframe includes receiving the first type of UCI using the first subframe on an uplink control channel. In other embodiments, receiving 905 the first type of UCI using the first subframe includes receiving the first type of UCI using the first subframe on an uplink data channel. In yet other embodiments, receiving 905 the first type of UCI using the first subframe includes both receiving the first type of UCI using a first subframe of the first subframe type on an uplink control channel and receiving the first type of UCI using another subframe of the first subframe type on an uplink data channel.

The method 900 includes receiving 910 a second type of UCI using a second subframe, the second subframe having a second subframe type, wherein the duration of the second subframe is larger than the duration of the first subframe. The method 900 ends. In one embodiment, a receiver of the wireless transceiver 325 receives 910 the second type of UCI using the second subframe, the second subframe having a second subframe type. In certain embodiments, a transmit time interval (“TTI”) of the second subframe is larger than the TTI of the first subframe. In some embodiments, receiving 910 the second type of UCI using the second subframe includes receiving the second type of UCI using the second subframe on an uplink control channel.

In some embodiments, receiving 905 the first type of UCI using the first subframe having the first subframe type and receiving 910 the second type of UCI using the second subframe having the second subframe type occurs simultaneously, such that the reception of the first type of UCI in the first subframe and the reception of the second type of UCI in the second subframe overlap in time. In certain embodiments, the wireless transceiver 325 receives uplink data on an uplink data channel using a third subframe of the first subframe type, wherein the reception of the first type of UCI in the first subframe, the reception of the second type of UCI in the second subframe, and the reception of the uplink data in the third subframe are overlapping in time.

In certain embodiments, the base unit 110 may transmit subframe type configuration information to a remote unit 105. In one embodiment, the subframe type configuration information includes an instruction to transmit the first type of UCI using a subframe of the first subframe type. In another embodiment, the subframe type configuration information includes an instruction to transmit on an uplink data channel using a subframe of the first subframe type. The first type of UCI may include HARQ feedback and/or a scheduling request. The second type of UCI may include CSI feedback.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
transmitting a first type of uplink control information (“UCI”) using a first subframe of a first subframe type; and
transmitting a second type of UCI using a second subframe, the second subframe having a second subframe type, wherein the duration of the second subframe is larger than the duration of the first subframe.

2. The method of claim 1, wherein transmitting the first type of UCI using the first subframe comprises transmitting the first type of UCI using the first subframe on an uplink control channel.

3. The method of claim 1, wherein transmitting the second type of UCI using the second subframe comprises transmitting the second type of UCI using the second subframe on an uplink control channel.

4. The method of claim 1, wherein transmitting the first type of UCI using the first subframe comprises transmitting the first type of UCI using the first subframe on an uplink data channel.

5. The method of claim 1, further comprising:
transmitting uplink data on an uplink data channel using a third subframe of the first subframe type.

6. The method of claim 5, wherein the transmission of the first type of UCI in the first subframe, the transmission of the second type of UCI in the second subframe, and the transmission of the uplink data in the third subframe are overlapping in time.

7. The method of claim 1, wherein the transmission of the first type of UCI in the first subframe and the transmission of the second type of UCI in the second subframe are overlapping in time.

8. The method of claim 1, further comprising:
receiving subframe type configuration information, wherein the subframe type configuration information configures transmitting the first type of UCI using a subframe of the first subframe type.

9. The method of claim 1, further comprising:
receiving subframe type configuration information, wherein the subframe type configuration information configures transmitting an uplink data channel using a subframe of the first subframe type.

10. The method of claim 1, wherein the first type of UCI comprises at least one of a hybrid automatic repeat request (“HARQ”) feedback and a scheduling request.

11. The method of claim 1, wherein the second type of UCI comprises channel state information (“CSI”) feedback.

12. An apparatus comprising:
a transmitter that:
transmits a first type of uplink control information (“UCI”) using a first subframe of a first subframe type; and
transmits a second type of UCI using a second subframe, the second subframe having a second subframe type, wherein the duration of the second subframe is larger than the duration of the first subframe.

13. The apparatus of claim 12, wherein the transmitter transmits the first type of UCI using the first subframe on an uplink control channel.

14. The apparatus of claim 12, wherein the transmitter transmits the second type of UCI using the second subframe on an uplink control channel.

15. The apparatus of claim 12, wherein the transmitter transmits the first type of UCI using the first subframe on an uplink data channel.

16. The apparatus of claim 12, wherein the transmitter further:
transmits uplink data on an uplink data channel using a third subframe of the first subframe type.

17. The apparatus of claim 16, wherein the transmission of the first type of UCI in the first subframe, the transmission of the second type of UCI in the second subframe, and the transmission of the uplink data in the third subframe are overlapping in time.

18. The apparatus of claim 12, wherein the transmission of the first type of UCI in the first subframe and the transmission of the second type of UCI in the second subframe are overlapping in time.

19. The apparatus of claim 12, further comprising:
a receiver that:
receives subframe type configuration information; and
a processor that
configures the transmitter to transmit the first type of UCI using a subframe of the first subframe type based on the subframe type configuration information.

20. The apparatus of claim 12, further comprising:
a receiver that:
receives subframe type configuration information; and
a processor that:
configures the transmitter to transmit an uplink data channel using a subframe of the first subframe type based on the subframe type configuration information.

21. The apparatus of claim 12, wherein the first type of UCI comprises at least one of a hybrid automatic repeat request (“HARQ”) feedback and a scheduling request.

22. The apparatus of claim 12, wherein the second type of UCI comprises channel state information (“CSI”) feedback.

23. A method comprising:
receiving a first type of uplink control information (“UCI”) via a first subframe of a first subframe type; and
receiving a second type of UCI via a second subframe, the second subframe having a second subframe type, wherein the duration of the second subframe is larger than the duration of the first subframe.

24. The method of claim 23, wherein receiving the first type of UCI using the first subframe comprises receiving the first type of UCI using the first subframe on an uplink control channel.

25. The method of claim 23, wherein receiving the second type of UCI using the second subframe comprises receiving the second type of UCI using the second subframe on an uplink control channel.

26. The method of claim 23, wherein receiving the first type of UCI using the first subframe comprises receiving the first type of UCI using the first subframe on an uplink data channel.

27. The method of claim 23, further comprising:
receiving uplink data on an uplink data channel using a third subframe of the first subframe type.

28. The method of claim 27, wherein the reception of the first type of UCI in the first subframe, the reception of the second type of UCI in the second subframe, and the reception of the uplink data in the third subframe are overlapping in time.

29. The method of claim 23, wherein the reception of the first type of UCI in the first subframe and the reception of the second type of UCI in the second subframe are overlapping in time.

30. The method of claim 23, further comprising:
transmitting subframe type configuration information, wherein the subframe type configuration information comprises an instruction to transmit the first type of UCI using a subframe of the first subframe type.

31. The method of claim 23, further comprising:
transmitting subframe type configuration information, wherein the subframe type configuration information comprises an instruction to transmit on an uplink data channel using a subframe of the first subframe type.

32. The method of claim 23, wherein the first type of UCI comprises at least one of a hybrid automatic repeat request (“HARQ”) feedback and a scheduling request.

33. The method of claim 23, wherein the second type of UCI comprises channel state information (“CSI”) feedback.

34. An apparatus comprising:
a receiver that:
receives a first type of uplink control information (“UCI”) using a first subframe of a first subframe type; and
receives a second type of UCI using a second subframe, the second subframe having a second subframe type, wherein the duration of the second subframe is larger than the duration of the first subframe.

35. The apparatus of claim 34, wherein the receiver receives the first type of UCI using the first subframe on an uplink control channel.

36. The apparatus of claim 34, wherein the receiver receives the second type of UCI using the second subframe on an uplink control channel.

37. The apparatus of claim 34, wherein the receiver receives the first type of UCI using the first subframe on an uplink data channel.

38. The apparatus of claim 34, wherein the receiver further:
receives uplink data on an uplink data channel using a third subframe of the first subframe type.

39. The apparatus of claim 38, wherein the reception of the first type of UCI in the first subframe, the reception of the second type of UCI in the second subframe, and the reception of the uplink data in the third subframe are overlapping in time.

40. The apparatus of claim 34, wherein the reception of the first type of UCI in the first subframe and the reception of the second type of UCI in the second subframe are overlapping in time.

41. The apparatus of claim 34, further comprising:
a transmitter that:
transmits subframe type configuration information, wherein the subframe type configuration information comprises an instruction to transmit the first type of UCI using a subframe of the first subframe type.

42. The apparatus of claim 34, further comprising
a transmitter that:
transmits subframe type configuration information, wherein the subframe type configuration information comprises an instruction to transmit on an uplink data channel using a subframe of the first subframe type.

43. The apparatus of claim 34, wherein the first type of UCI comprises at least one of a hybrid automatic repeat request (“HARQ”) feedback and a scheduling request.

44. The apparatus of claim 34, wherein the second type of UCI comprises channel state information (“CSI”) feedback.
